(19) United States
(12) Patent Application Publication
(10) Pub. No.: US 2011/0143912 A1
(43) Pub. Date: Jun. 16, 2011

(54) COLORED SPINEL OPTOCERAMICS

(76) Inventors: Yvonne MENKE, Mainz (DE); Peter Blaum, Bodenheim (DE); Ulrich Peuchert, Bodenheim (DE); Yoshio Okano, Tsokuba Ibaraki (JP)

(21) Appl. No.: 12/948,965

(22) Filed: Nov. 18, 2010

(30) Foreign Application Priority Data
Nov. 20, 2009 (DE) 10 2009 055 984.1

(51) Int. Cl. C04B 35/44; C04B 35/49; C04B 35/465; C04B 35/47; C04B 35/468; C04B 35/50; C04B 35/547; C04B 35/495; C04B 35/453; C04B 35/443; C04B 35/64; C04B 35/645

(52) U.S. Cl. 501/137; 501/134; 501/135; 501/136; 501/152; 501/153; 501/1; 264/2.6

(57) ABSTRACT

A transparent, polycrystalline ceramic is described. The ceramic comprises crystallites of the formula AₓCᵤB_{y}DᵥE_{z}F_{w}, whereby A and C are selected from the group consisting of Li⁺, Na⁺, Be²⁺, Mg²⁺, Ca²⁺, Sr²⁺, Ba²⁺, Al³⁺, Ga³⁺, In³⁺, C⁴⁺, Si⁴⁺, Ge⁴⁺, Sn^{2+/4+}, Sc³⁺, Ti⁴⁺, Zn²⁺, Zr⁴⁺, Mo⁶⁺, Ru⁴⁺, Pd²⁺, Ag²⁺, Cd²⁺, Hf⁴⁺, W^{4+/6+}, Re⁴⁺, Os⁴⁺, Ir⁴⁺, Pt^{2+/4+}, Hg²⁺ and mixtures thereof, B and D are selected from the group consisting of Li⁺, Na⁺, K⁺, Mg²⁺, Al³⁺, Ga³⁺, In³⁺, Si⁴⁺, Ge⁴⁺, Sn⁴⁺, Sc³⁺, Ti⁴⁺, Zn²⁺, Y³⁺, Zr⁴⁺, Nb³⁺, Ru³⁺, Rh³⁺, La³⁺, Lu³⁺, Gd³⁺ and mixtures thereof, E and F are selected mainly from the group consisting of the divalent anions of S, Se and O and mixtures thereof, x, u, y, v, z and w satisfy the following formulae

0.125<(x+u)/(y+v)≦0.55

z+w=4

and at least 95% by weight of the crystallites display symmetric, cubic crystal structures of the spinel type, with the proviso that when A=C=Mg²⁺ and B=D=Al³⁺, E and F cannot both be O, and whereby the optoceramic is additionally doped with 100 ppm to 20 at. % of at least one optically active cation selected from the group consisting of Ce³⁺, Sm^{2+/3+}, Eu^{2+/3+}, Nd³⁺, Er³⁺, Yb³⁺, Co²⁺, Cr^{2+/3+/6+}, V^{3+/4+}, Mn²⁺, Fe^{2+/3+}, Ni²⁺ and Cu²⁺.

### BACKGROUND OF THE INVENTION

### Cross References to Related Applications

This application claims priority from German patent application 10 2009 055 984.1, filed on Nov. 20, 2009. The entire content of this priority application is incorporated herein by reference.

The present invention relates to colored optoceramics, their use and methods for their manufacture. The present invention further relates to active and passive optical elements made of optoceramics as well as laser systems which comprise such optical elements.

For the purposes of the present invention, the term “optoceramic” refers to an essentially single-phase polycrystalline oxide-based material having a high transparency. Optoceramics are accordingly understood to be a specific subgroup of ceramics.

For the purposes of the present invention, the term “single-phase” means that more than 95% of the material, preferably at least 97%, more preferably at least 99% and particularly preferably from 99.5 to 99.9%, of the material is present in the form of crystals having the target composition. The individual crystallites are closely packed and densities of at least 99%, preferably 99.9% and more preferably 99.99%, based on the theoretical values are achieved. The optoceramics are thus virtually pore-free.

Optoceramics differ from conventional glass-ceramics in that the latter comprise not only a crystalline phase but also a high proportion of an amorphous glass phase. Furthermore, conventional ceramics do not have the high densities present in optoceramics. Neither glass-ceramics nor conventional ceramics can have the advantageous properties of optoceramics, such as particular refractive indices, Abbe numbers, values for relative partial dispersion and especially the advantageous high transparency for light in the visible range and/or in the infrared range.

An objective in the development of laser systems is the provision of laser systems which display a high resistance towards environmental influences and in particular mechanical environmental influences such as shocks and impacts.

Single-crystalline materials are usually used in laser systems and particularly as laser crystals.

However, the production of single crystals by the known crystal drawing processes is very costly and subject to considerable restrictions in respect of the chemical composition. Furthermore, single crystals cannot be produced with a shape close to the end shape for most applications, resulting in a considerable outlay for final machining, possibly in combination with a high removal of material. This also means that it is frequently necessary to produce single crystals which are significantly larger than the optical element desired in the end.

The Japanese published specification JP 2000-203933 discloses, for example, the production of polycrystalline YAG by means of a specific sintering process. Furthermore, the production of polycrystalline YAG of optical quality, for example for doping with laser-active ions such as Nd, has recently also been successful.

Ji et al. (“La₂Hf₂O₇: Ti⁴⁺ Ceramic scintillator for X-ray imaging”, J. Mater Res. Vol. 20 (3) 567-570 (2005)) describe transparent ceramics having the composition La₂Hf₂O₇. The material described there is doped with titanium. Further ceramics of this type which are doped with other dopants such as Eu⁴⁺, Tb³⁺ or Ce³⁺ are described, for example, in Ji et al. (“Preparation and spectroscopic properties of La₂Hf₂O₇ Tb” Materials Letters, 59 (8-9), 868-871, Apr 2005 and “Fabrication and spectroscopic investigation of La₂Hf₂O₇-based phosphors”. High Performance Ceramics III, parts 1 and 2, 280-283; 577-579 1:2). Furthermore, the abovementioned authors have also described undoped variants of the abovementioned compounds (“Fabrication of transparent La₂Hf₂O₇ ceramics from combustion synthesized powders” Mat. Res. Bull. 40 (3) 553-559 (2005)).

More recent developments in patents in the field of optically transparent inorganic ceramic materials are summarized, for example, in the review article by Silva et al. (Recent Patents on Material Science 2008, 1, 56-73). This article describes optically transparent inorganic materials which include aluminium oxides, aluminium oxynitrides, perovskites, yttrium aluminium garnets, PLZT ceramics, Mg—Al spinels, yttrium oxides and REE oxides.

To solve the abovementioned problems, optionally doped spinel ceramics having the compositions MgO—Al₂O₃ have also been taken into consideration for some time. Examples of such ceramics are disclosed, for example in the following documents, namely U.S. Pat. No. 3,516,839, U.S. Pat. No. 3,531,308, U.S. Pat. No. 4,584,151, EP 0 334 760 B1, U.S. Pat. No. 3,974,249, WO 2006/104540 A2, U.S. Pat. No. 3,767,745, EP 0 447 390 B1, U.S. Pat. No. 5,082,739, EP 0 332 393 A1, U.S. Pat. No. 4,273,587, GB 2,031,339, JP 04016552 and WO 2008/090909. However, since all these documents describe the same host medium for doping, such ceramics can be matched to different requirements to only a limited extent.

### SUMMARY OF THE INVENTION

It is therefore an object of the present invention to provide a doped material having a high refractive index, a high Abbe number and/or an excellent specific relative partial dispersion as well as a low stress-induced birefringence, where, in particular, these parameters cannot be achieved using conventional glasses, single-crystalline materials and crystalline ceramics or materials. A further objective of the invention is to describe a method for the manufacture of a material having the same parameters.

A further objective of the present invention is to provide an optical element which displays excellent optical properties combined with high chemical resistance and mechanical strength.

It is also an objective of the present invention to provide a laser system which displays improved resistance towards environmental influences.

It has surprisingly been found that the use of materials having spinel structures of a different type than the composition type MgAl₂O₄ allows optoceramics having excellent optical properties, in particular a high refractive index, a high Abbe number as well as an excellent relative partial dispersion, to be obtained. These materials can be doped with various optically active ions in order to produce new materials, e.g. for use in laser systems. Furthermore, such materials display excellent transparency both in the region of visible light and in the infrared range as well as excellent mechanical, thermal and chemical stability.

In addition, in contrast to single crystals and glasses, higher degrees of doping can be achieved in ceramics since no segregation (as in the melt) of the dopants and thus no concentration quenching, which has an adverse effect on the laser properties of the material, occurs here.

The invention therefore relates to an optoceramic comprising crystallites of the formula AₓCᵤB_{y}DᵥE_{z}F_{w}, whereby

A and C are selected from the group consisting of Li⁺, Na⁺, Be²⁺, Mg²⁺, Ca²⁺, Sr²⁺, Ba²⁺, Al³⁺, Ga³⁺, In³⁺, C⁴⁺, Si⁴⁺, Ge⁴⁺, Sn^{2+/4+}, Sc³⁺, Ti⁴⁺, Zn²⁺, Zr⁴⁺, Mo⁶⁺, Ru⁴⁺, Pd²⁺, Ag²⁺, Cd²⁺, Hf⁴⁺, W^{4+/6+}, Re⁴⁺, Os⁴⁺, Ir⁴⁺, Pt^{2+/4+}, Hg²⁺ and mixtures thereof,

B and D are selected from the group consisting of Li⁺, Na⁺, K⁺, Mg²⁺, Al³⁺, Ga³⁺, In³⁺, Si⁴⁺, Ge⁴⁺, Sn⁴⁺, Sc³⁺, Ti⁴⁺, Zn²⁺, Y³⁺, Zr⁴⁺, Nb³⁺, Ru³⁺, Rh³⁺, La³⁺, Lu³⁺, Gd³⁺ and mixtures thereof,

E and F are selected mainly from the group consisting of the divalent anions of S, Se and O and mixtures thereof,

x, u, y, v, z and w satisfy the following formulae

0.125<(x+u)/(y+v)≦0.55

z+w=4

and

at least 95% by weight of the crystallites display symmetric, cubic crystal structures of the spinel type, with the proviso that when A=C=Mg²⁺ and B=D=Al³⁺, E and F cannot both be O, and

whereby the optoceramic is additionally doped with 100 ppm to 20 at. % of at least one optically active cation selected from the group consisting of Ce³⁺, Sm^{2+/3+}, Eu^{2+/3+}, Nd³⁺, Er³⁺, Yb³⁺, Co²⁺, Cr^{2+/3+/6+}, V^{3+/4+}, Mn²⁺, Fe^{2+/3+}, Ni²⁺ and Cu²⁺.

An optoceramic for the purposes of the invention is a ceramic which consists of a crystal composite in which the individual crystallites have a cubic structure of the spinel type. According to the invention, at least 95% by weight of the crystallites, preferably more than 98% and more preferably more than 99% of the crystallites, have symmetric cubic crystal structures of the spinel type. The cubic crystals are preferably present very close to one another as a defect-free microstructure.

In the ceramics of the invention, the cations used for doping are built into the spinel structure and there replace, depending on size and valency, one or more of the cations A, B, C or D. Here, it is clear that, depending on the amount added of the cations used for doping, not all cations A, B, C or D are replaced in the ceramic.

All mixed crystal phases have a cubic crystal structure which is isotypic with that of MgAl₂O₄. This structure type is described by way of example in E. Riedel, Anorganische Chemie, Walter de Gruyter Berlin, New York (1994).

In the oxides AB₂O₄ having a spinel structure, eight negative anions have to be neutralized by the cations, which can be achieved by the following three combinations of cations: (A²⁺+2B³⁺, A⁴⁺+2B²⁺ and A⁶⁺+2B⁺). These compounds are also referred to as 2,3-, 4,2- and 6,1-spinels. In the spinel structure, two thirds of the cations are octahedrally coordinated and one third of the cations is tetrahedrally coordinated. Normal spinels have the ion distribution A(BB)O₄, with the ions which occupy octahedral sites being shown in parentheses. Spinels having the ion distribution B(AB)O₄ are referred to as inverse spinels. Spinels in which the ion distribution is between these two boundary types are also known. Optoceramics for the purposes of the present invention can have all types of spinel structure, but preference is given to only a single structure type being present in order to avoid refractive index inhomogeneities.

It is also clear that, even though the above statements have been made with reference to binary stoichiometric spinels, the optoceramics of the present invention can also have nonstoichiometric mixed spinel structures as long as these meet the abovementioned conditions.

Owing to their cubic structure, the polycrystalline optoceramics are dielectric. Thus, no permanent dipoles occur and the material behaves optically isotropically.

Apart from the divalent anions of S, Se and O and mixtures thereof, E and F can comprise any other anion as long as the abovementioned divalent anions make up the major part, i.e. at least 50%, of E and F. Customary sources of other anions are, for example, inorganic compounds added as sintering aids, such as AlF₃, MgF₂ or other fluorides of the metals present in the spinels.

In one embodiment of the invention, A and C are selected from the group consisting of Li⁺, Mg²⁺, Ca²⁺, Sr²⁺, Ba²⁺, Al³⁺, Ga³⁺, In³⁺, Ge⁴⁺, Sc³⁺, Zn²⁺, Zr⁴⁺, Cd²⁺, Hf⁴⁺ and mixtures thereof, in particular from the group consisting of Mg²⁺, Ca²⁺, Sr²⁺, Ba²⁺, Sc³⁺, Zn²⁺, Cd²⁺, Hf⁴⁺ and mixtures thereof, and particularly preferably from the group consisting of Mg²⁺, Ca²⁺, Sr²⁺, Zn²⁺ and mixtures thereof.

In a further embodiment, B and D are selected from the group consisting of Li⁺, Na⁺, K⁺, Mg²⁺, Al³⁺, Ga³⁺, In³⁺, Sc³⁺, Zn²⁺, Y³⁺, Zr⁴⁺, Nb³⁺, Ru³⁺, Rh³⁺, La³⁺, Gd³⁺ and mixtures thereof, in particular from the group consisting of Mg²⁺, Al³⁺, Ga³⁺, In³⁺, Sc³⁺, Zn²⁺, Y³⁺, Nb³⁺, Ru³⁺, Rh³⁺, La³⁺, Gd³⁺ and mixtures thereof, and particularly preferably from the group consisting of Al³⁺, Ga³⁺, In³⁺, Y³⁺, La³⁺, Gd³⁺ and mixtures thereof.

It has been found that optoceramics which comprise the abovementioned cations have particularly advantageous properties and very particularly advantageous optical properties. Optoceramics which comprise the abovementioned cations have, in particular, a high refractive index and a high Abbe number.

In a further embodiment of the invention, x, u, y and v satisfy the following relationship 0.3<(x+u)/(y+v)≦0.55, in particular 0.4<(x+u)/(y+v)≦0.5 and particularly preferably 0.45<(x+u)/(y+v)≦0.5. In particular, the crystallites have a stoichiometric composition in which the following applies:

x+u=1,

y+v=2,

z+w=4 and

2x+2u+3y+3v=8.

Ceramics which fall within the abovementioned parameters likewise have particularly advantageous properties, in particular advantageous optical properties.

In a further embodiment of the invention, E and F comprise at least 90%, preferably at least 95% and particularly preferably at least 98%, divalent anions of S, Se and O and mixtures thereof.

Even though the optoceramics of the invention can comprise further anions which result, for example from inorganic compounds added to improve sintering, preference is given, in particular in respect of the optical isotropy, to E and F being divalent anions of S, Se and O to the greatest possible extent.

In a further embodiment of the invention, the optoceramic has a transparency of >50%, preferably >70%, more preferably >80%, more preferably >90%, particularly preferably >95%, outside the absorption bands of the ions used for doping in a window having a width of at least 200 nm in the region of visible light having wavelengths from 380 nm to 800 nm, preferably in a window from 450 to 750 nm or in a window from 600 to 800 nm, at a sample thickness of 2 mm, preferably at a sample thickness of 3 mm, particularly preferably at a sample thickness of 5 mm.

In a further embodiment of the invention, the optoceramic has a transparency of >50%, preferably >70%, more preferably >80%, more preferably >90%, particularly preferably >95%, outside the absorption bands of the ions used for doping in a window having a width of at least 1000 nm in the infrared range from 800 nm to 5000 nm, preferably in a window from 3000 to 4000 nm, at a sample thickness of 2 mm, preferably at a sample thickness of 3 mm, particularly preferably at a sample thickness of 5 mm.

Optoceramics having the abovementioned transparency parameters have been found to be particularly advantageous for, in particular, applications in the field of industrial laser systems but also as filters and as light-converting material.

In a further embodiment of the invention, the optoceramic has a refractive index which is greater than 1.72, preferably from 1.74 to 2.3 and particularly preferably from 1.75 to 2.0.

In a further embodiment of the invention, the optoceramic has an Abbe number from 40 to 80, preferably from 50 to 70.

In a further embodiment of the invention, the optoceramic has a stress-induced birefringence of <20 nm/cm, preferably <10 nm/cm and in particular <5 nm/cm.

The invention further relates to a method for manufacturing an optoceramic of the invention, which comprises the following steps

(1) production of a homogeneous powder mixture by mixing the powder raw materials having an average primary particle diameter of 20 nm to 1 μm, preferably 20 to 500 nm, in accordance with the desired composition, optionally with the addition of additives such as binders, sintering aids and dispersants in a solvent and drying the slurry to give a powder,

(2) production of a preform from the powder obtained in step (1),

(3) optionally burning-out of any dispersants and binders present from the preform at temperatures of 500 to 900° C.,

(4) sintering the preform at temperatures of 1400 to 1900° C.,

(5) optionally pressure sintering the sintered body obtained in step (4) at 1400 to 2000° C. under a pressure of 10 to 300 MPa, preferably 50 to 250 MPa and in particular 100 to 200 MPa, and

(6) optionally oxidation of the optoceramic obtained in step (4) or (5) in a stream of O₂ at temperatures of up to 1000° C. for 5 to 10 hours.

The amounts of powder used in step (1) of the method can readily be determined by a person skilled in the art from the desired stoichiometry of the end product. Ideally, the compositions deviate by not more than 10 mol %, ideally not more than 5 mol %, from the target composition. Here, too much or too little of one of the oxides can ideally be compensated by the crystal structure within the limits of complete miscibility. Powders used are either individual oxides which after homogenization and sintering have the final stoichiometry or compound powders which already have the final stoichiometry before sintering.

The solvents used in step (1) can be any solvent known to those skilled in the art. Preference is given to using water, short-chain alcohols or mixtures thereof. Particularly preferred solvents are water, ethanol, isopropanol and mixtures thereof.

The sintering in step (4) is preferably carried out under reduced pressure or under an H₂/N₂ gas mixture; vacuum sintering takes place in a pressure range from 1 bar absolute to 10⁻⁷ mbar absolute, preferably in a pressure range from 10⁻³ to 10⁻⁷ mbar.

The invention also relates to an optical element which comprises an optoceramic of the invention. This optical element is preferably a laser ceramic, a filter or an optical converter.

The invention further relates to a laser system which comprises at least one optical element according to the invention.

The invention further relates to the use of the optoceramic of the invention for the manufacture of an optical element.

It goes without saying that the abovementioned features and the features still to be explained below cannot only be used in the combination indicated but also in other combinations or on their own, without leaving the scope of the present invention.

The invention will now be illustrated in more detail with the aid of examples and with reference to the accompanying FIGURE.

### BRIEF DESCRIPTION OF THE DRAWINGS

FIG. 1 shows, highly schematically, a laser system according to the invention.

### DESCRIPTION OF PREFERRED EMBODIMENTS

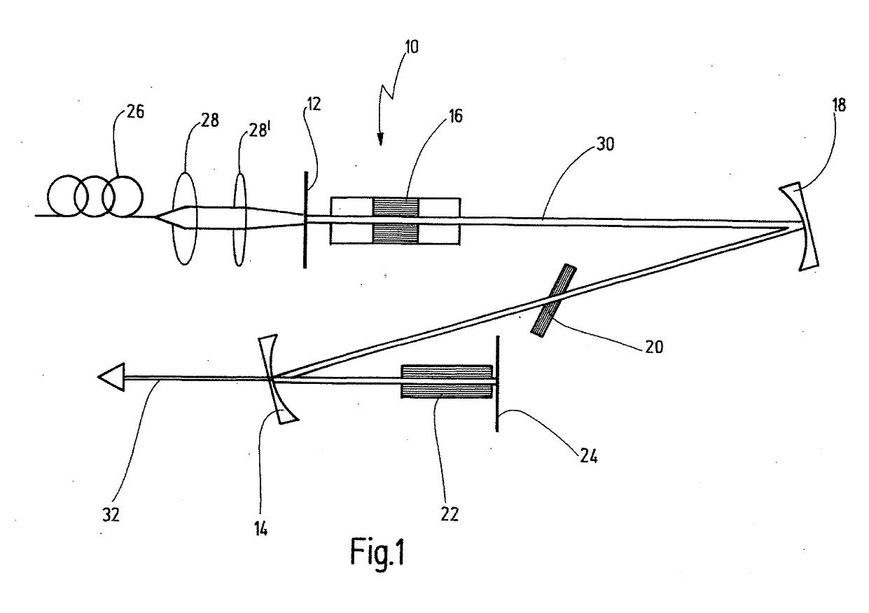

In FIG. 1, a laser system in the form of a laser is denoted in its entirety by the reference numeral 10.

The laser system 10 comprises a laser cavity which is bounded on two sides by an entry mirror 12 and an exit mirror 14.

Within the laser cavity, a laser-active medium 16 is arranged downstream of the entry mirror 12. This laser-active medium comprises a doped optoceramic of the spinel type, in the present case a Cr-doped Zn(Al, Lu)₂O₄ spinel ceramic as can, for example, be produced according to Example 5 below. Downstream of the laser-active medium 16 there is a parabolic mirror 18 which serves firstly to focus laser light and secondly to deflect the laser light. From this parabolic mirror 18, laser light exiting from the laser-active medium 16 is reflected via a Brewster window 20 onto the exit mirror 14. The Brewster window 20 serves to polarize the laser light.

The laser light is at least partly deflected by the exit mirror 14 onto a lithium triborate crystal 22 which is used here for doubling the frequency, with the laser beam passing through the lithium triborate crystal 22 and then impinging on a plane mirror 24 and being reflected there. The plane mirror 24 then reflects the laser light in the direction of the exit mirror 14. Since in the present case the exit mirror 14 is a parabolic mirror having a hole, the now polarized and coherent laser light can exit the laser cavity as a laser beam through the exit mirror.

In operation, light from a light source, which in the present case is an optical fibre 26, is shone via a condenser system, which is made up of two lenses 28 and 28′, through the entry mirror 12, which is a unidirectionally reflecting mirror, into the laser cavity. The incoming light there impinges on the laser-active medium 16 and is converted by reflection in the laser cavity and entry into and exit from the laser-active medium 16 into laser light 30. This laser light 30 is reflected by the parabolic mirror 18 through the Brewster window 20 onto the exit mirror 14. The laser light 30 is polarized by the Brewster window 20.

At the exit mirror 14, which is a parabolic mirror having a hole, the laser light 30 is shone onto the lithium triborate crystal 22 where doubling of the frequency takes place. After passing through the lithium triborate crystal 22, the laser light 30 is reflected at a plane mirror 24 and then exits the laser cavity as laser beam 32 through a hole in the exit mirror 14.

In the present case, the colored ceramics are used as laser-active medium in the system described. However, they can also be used as, for example, optical converters or filters in such laser systems, as is known to those skilled in the art.

### Production of Colored Ceramics

### EXAMPLE 1

### Production of a Colored Ceramic Composed of 2.5 at. % Yb:ZnAl₂O₄ by Dry Pressing

Powders having primary particles having diameters of <1 μm, preferably having nanosize diameters (≦300 nm), of ZnO, Al₂O₃ and Yb₂O₃ are weighed out in a ratio corresponding to the target composition and mixed and homogenized in a ball mill. Milling is carried out in ethanol using Al₂O₃ balls, with binders, dispersant additives (surfactants) and further auxiliaries known to those skilled in the art being added to the suspension being milled. Milling is carried out overnight.

The milled suspension is either dried on a rotary evaporator or granulated in a spray drier.

The powder is subsequently uniaxially pressed to give discs. The shapes are preferably such that at least one surface reproduces the contour of the finished element. The pressure conditions are in the range from 10 to 50 MPa, and the pressing times range from a few seconds to 1 minute. The preshaped compact is repressed in a cold isostatic press using a pressing pressure in the range from 100 to 300 MPa. The pressure transmission medium is oil.

Any binder present is subsequently burnt out in a first thermal step. Heating time and temperature are 180 minutes and 700° C. The burnt-out green body is subsequently sintered in a vacuum sintering furnace (reduced pressure: 10⁻⁵-10⁻⁶ mbar), if desired in hydrogen or helium. The sintering temperatures and times depend on the melting points or phase formation temperatures of the target composition. In the case of ZnAl₂O , these are about 1850° C./5 h.

In the subsequent hot isostatic pressing (HIP), the closed pores are eliminated. The HIP conditions are, for example, 1750° C.-60 min-Ar-200 MPa. Depending on the chemistry and the susceptibility of the system to reduction, the sample can be reoxidized in a further thermal step (e.g. 900° C., 5 hours, air) after the hot isostatic pressing.

Colored, homogeneous bodies which can be processed further are obtained.

### EXAMPLE 2

### Production of a Colored Ceramic Composed of (0.5 at. % Ce and 1.5 at. % Eu₂O₃):(Mg, Zn)Al₂O₄ by Hot Casting

In a heated ball mill, the ceramic nanosize CeO₂, Eu₂O₃, MgO, ZnO, Al₂O₃ powder mixture is mixed with the thermoplastic binder (mixture of 75% by mass of paraffin and 25% by mass of microwax) and the surface-active agent siloxane polyglycol ether (monomolecular coverage of the ceramic particle surface) and sintering aids at 80° C. Here, the viscosity of the final slip is 2.5 Pas at a solids content of 60% by volume. The slip is conveyed directly into the plastic mould held against the mill by means of an injection pressure of 1 MPa (hot casting). After removal from the mould, the binder is driven off at temperatures above the melting point of the wax used, leaving about 3% by mass in the green body in order to ensure dimensional stability. The binders and surfactants which now remain in the green body are burnt out at 600° C. for 3 hours.

Vacuum sintering is carried out at a heating rate of 300 K/h up to 1650° C. and a hold time of 10 hours. The vacuum conditions are from 10⁻⁵ to 10⁻⁶ mbar. HIPping is carried out at a heating rate of 300 K/min up to 1730° C. and a hold time of 10 hours under a pressure of 200 MPa. Post-annealing at a temperature of 1100° C. is carried out in air at a heating rate of 150 K/h.

### EXAMPLE 3

### Production of a Colored Ceramic Composed of 1 at. % Nd:(Zn, Sr)(Gd, Al)₂O₄ by Uniaxial Pressing

Powders having primary particles having diameters of <1 μm, preferably having “nanosize” diameters (<250 nm), of ZnO, SrO, Gd₂O₃, Al₂O₃ and Nd₂O₃ are weighed out in a ratio corresponding to the target composition. After the addition of dispersants, sintering aids and binders, the mixture is mixed with ethanol and Al₂O₃ balls in a ball mill for from 12 to 16 hours.

The milled suspension is either dried on a hotplate or on a rotary evaporator or granulated in a spray drier.

The powder is subsequently uniaxially pressed to form discs. The shapes are preferably such that at least one surface reproduces the contour of the finished element. The pressure conditions are in the range from 10 to 50 MPa, and the pressing times range from a few seconds to 1 minute. The preshaped compact is repressed in a cold isostatic press using a pressing pressure from 100 to 300 MPa. The pressure transmission medium is water or oil.

Any binder present is subsequently burnt out in a first thermal step. The heating time is 1-3 hours at temperatures in the range from 600 to 1000° C. The burnt-out green body is subsequently sintered in a vacuum sintering furnace (reduced pressure: 10⁻⁵-10⁻⁶ mbar), if desired in hydrogen or helium. The sintering temperatures and times depend on the sintering behaviour of the mixture, i.e. after the formation of the composition a further densification to give a ceramic having few or no pores takes place. Sintering to give a virtually pore-free body is carried out at higher temperatures in the range from 1600 to 1900° C. for 2 to 10 hours.

In the subsequent hot isostatic pressing (HIP), the closed pores are eliminated; the HIP conditions are, for example, 1780° C.-2 h-Ar-200 MPa. Depending on the chemistry and the susceptibility of the system to reduction, the sample can be reoxidized in a further thermal step (e.g. 1000° C., 5 hours, O₂ stream) after the hot isostatic pressing.

Colored, homogeneous bodies which can be processed further are obtained.

### EXAMPLE 4

### Production of a Colored Ceramic Composed of 2 at. % Co:SrAl₂O₄ by Hot Casting

In a heated ball mill, the ceramic nanosize SrO, Co₂O₃ and Al₂O₃ powder mixture is mixed with the thermoplastic binder (mixture of 75% by mass of paraffin and 25% by mass of microwax) and the surface-active agent siloxane polyglycol ether (monomolecular coverage of the ceramic particle surface) at 80° C. Here, the viscosity of the final slip is 2.5 Pas at a solids content of 60% by volume. The slip is conveyed directly into the plastic mould held against the mill by means of an injection pressure of 1 MPa (hot casting). After removal from the mould, the binder is driven off at temperatures above the melting point of the wax used, leaving about 3% by mass in the green body in order to ensure dimensional stability. The binders and surfactants which now remain in the green body are burnt out at 600° C. for 3 hours.

Vacuum sintering is carried out at a heating rate of 200 K/h up to 1675° C. and a hold time of 10 hours. The vacuum conditions are from 10⁻⁵ to 10⁻⁶ mbar. HIPping is carried out at a heating rate of 300 K/min up to 1700° C. and a hold time of 10 hours under a pressure of 200 MPa.

### EXAMPLE 5

### Production of a Colored Ceramic Composed of 1 at. % Cr:Zn(Al, Lu)₂O₄ by Uniaxial Pressing

Powders having primary particles having diameters of <1 μm, preferably having nanosize diameters (<250 nm), of ZnO, Al₂O₃, Cr₂O₃ and Lu₂O₃ are weighed out in a ratio corresponding to the target composition. After the addition of dispersants, the mixture is mixed with ethanol and Al₂O₃ balls in a ball mill for 10 hours.

After drying on a rotary evaporator, the powder is heated at 1200° C. in a pure Al₂O₃ container for 5 hours. The cooled powder is then mixed with dispersants, binders and sintering additives and again ethanol and Al₂O₃ balls in a ball mill for 12 hours. The milled suspension is either dried on a hotplate or on a rotary evaporator or granulated in a spray drier.

The powder is subsequently uniaxially pressed to form discs. The shapes are preferably such that at least one surface reproduces the contour of the finished element. The pressure conditions are in the range from 10 to 50 MPa, and the pressing times range from a few seconds to 1 minute. The preshaped compact is repressed in a cold isostatic press using a pressing pressure in the range from 100 to 300 MPa. The pressure transmission medium is water or oil.

Any binder present is subsequently burnt out in a first thermal step. The heating time is 1-3 hours at temperatures in the range from 600 to 1000° C. The burnt-out green body is subsequently sintered in a vacuum sintering furnace (reduced pressure: 10⁻⁵-10⁻⁶ mbar), if desired in hydrogen or helium. The sintering temperatures and times depend on the sintering behaviour of the mixture, i.e. after the formation of the composition, a further densification to give a ceramic having few or no pores takes place. Sintering to give a virtually pore-free body is carried out at higher temperatures, in the range from 1600 to 1800° C., for 2 to 10 hours.

In the subsequent hot isostatic pressing (HIP), the closed pores are eliminated; the HIP conditions are, for example, 1780° C.-2 h-Ar-200 MPa. Depending on the chemistry and susceptibility of the system to reduction, the sample can be reoxidized in a further thermal step (e.g. 1000° C., 5 hours, O₂ stream) after the hot isostatic pressing.

Colored, homogeneous bodies which can be processed further are obtained.

### EXAMPLE 6

### Production of a Colored Ceramic Composed of 1 at % Sm:(Mg, Zn)(Al, Ga)₂O₄ by Uniaxial Pressing (with Reactive Sintering)

Powders having primary particles having diameters of <1 μm, preferably having nanosize diameters (≦100 nm), of MgO, ZnO, Al₂O₃, Sm₂O₃ and Ga₂O₃ are weighed out in a ratio corresponding to the target composition. After the addition of dispersants, the mixture is mixed with ethanol and Al₂O₃ balls in a ball mill for 10 hours.

After drying on a rotary evaporator, the powder is heated at 1200° C. in a pure Al₂O₃ container for 5 hours. The cooled powder is then mixed with dispersants, binders and sintering aids and again with ethanol and Al₂O₃ balls in a ball mill for 12 hours. The milled suspension is either dried on a hotplate or on a rotary evaporator or granulated in a spray dryer.

The powder is subsequently uniaxially pressed to form discs. The shapes are preferably such that at least one surface reproduces the contour of the finished element. The pressure conditions are in the range from 10 to 50 MPa, and the pressing times range from a few seconds to 1 minute. The preshaped compact is repressed in a cold isostatic press using a pressing pressure of 100 to 300 MPa. The pressure transmission medium is water or oil.

Any binder present is subsequently burnt out in a first thermal step. The heating time is 1-3 hours at temperatures in the range from 600 to 1000° C. The burnt-out green body is subsequently sintered in a vacuum sintering furnace (reduced pressure: 10⁻⁵-10⁻⁶ mbar), if desired in hydrogen or helium. The sintering temperatures and times depend on the sintering behaviour of the mixture, i.e. after the formation of the composition, a further densification to give a ceramic having few or no pores takes place. Sintering to give a virtually pore-free body is carried out at higher temperatures in the range from 1600 to 1900° C. for 3 to 15 hours.

In the subsequent hot isostatic pressing (HIP), the closed pores are eliminated; the HIP conditions are, for example, 1700° C.-2 h-Ar-200 MPa. Depending on the chemistry and the susceptibility of the system to reduction, the sample can be reoxidized in a further thermal step (e.g. 1000° C., 5 hours, O₂ stream) after the hot isostatic pressing.

Colored, homogeneous bodies which can be processed further are obtained.

What is claimed is:

1. An optoceramic having crystallites of the formula AₓCᵤB_{y}DᵥE_{z}F_{w}, whereby
A and C are selected from the group consisting of Li⁺, Na⁺, Be²⁺, Mg²⁺, Ca²⁺, Sr²⁺, Ba²⁺, Al³⁺, Ga³⁺, In³⁺, C⁴⁺, Si⁴⁺, Ge⁴⁺, Sn^{2+/4+}, Sc³⁺, Ti⁴⁺, Zn²⁺, Zr⁴⁺, Mo⁶⁺, Ru⁴⁺, Pd²⁺, Ag²⁺, Cd²⁺, Hf⁴⁺, W^{4+/6+}, Re⁴⁺, Os⁴⁺, Ir⁴⁺, Pt^{2+/4+}, Hg²⁺ and mixtures thereof,
B and D are selected from the group consisting of Li⁺, Na⁺, K⁺, Mg²⁺, Al³⁺, Ga³⁺, In³⁺, Si⁴⁺, Ge⁴⁺, Sn⁴⁺, Sc³⁺, Ti⁴⁺, Zn²⁺, Y³⁺, Zr⁴⁺, Nb³⁺, Ru³⁺, Rh³⁺, La³⁺, Lu³⁺, Gd³⁺ and mixtures thereof,
E and F are selected mainly from the group consisting of the divalent anions of S, Se and O and mixtures thereof,
x, u, y, v, z and w satisfy the following formulae
0.125<(x+u)/(y+v)≦0.55
z+w=4
and
at least 95% by weight of said crystallites display symmetric, cubic crystal structures of the spinel type, with the proviso that when A=C=Mg²⁺ and B=D=Al³⁺, E and F cannot both be O, and
whereby said optoceramic is additionally doped with 100 ppm to 20 at. % of at least one optically active cation selected from the group consisting of Ce³⁺, Sm^{2+/3+}, Eu^{2+/3+}, Nd³⁺, Er³⁺, Yb³⁺, Co²⁺, Cr^{2+/3+/6+}, V^{3+/4+}, Mn²⁺, Fe^{2+/3+}, Ni²⁺ and Cu²⁺.

2. The optoceramic of claim 1, wherein A and C are selected from the group consisting of Li⁺, Mg²⁺, Ca²⁺, Sr²⁺, Ba²⁺, Al³⁺, Ga³⁺, In³⁺, Ge⁴⁺, Sc³⁺, Zn²⁺, Zr⁴⁺, Cd²⁺, Hf⁴⁺ and mixtures thereof, in particular from the group consisting of Mg²⁺, Ca²⁺, Sr²⁺, Ba²⁺, Sc³⁺, Zn²⁺, Cd²⁺, Hf⁴⁺ and mixtures thereof, and particularly preferably from the group consisting of Mg²⁺, Ca²⁺, Sr²⁺, Zn²⁺ and mixtures thereof.

3. The optoceramic of claim 1, wherein B and D are selected from the group consisting of Li⁺, Na⁺, K⁺, Mg²⁺, Al³⁺, Ga³⁺, In³⁺, Sc³⁺, Zn²⁺, Y³⁺, Zr⁴⁺, Nb³⁺, Ru³⁺, Rh³⁺, La³⁺, Gd³⁺ and mixtures thereof, in particular from the group consisting of Mg²⁺, Al³⁺, Ga³⁺, In³⁺, Sc³⁺, Zn²⁺, Y³⁺, Nb³⁺, Ru³⁺, Rh³⁺, La³⁺, Gd³⁺ and mixtures thereof, and particularly preferably from the group consisting of Al³⁺, Ga³⁺, In³⁺, Y³⁺, La³⁺, Gd³⁺ and mixtures thereof.

4. The optoceramic of claim 1, wherein x, u, y and v satisfy the following relationships,
0.3<(x+u)/(y+v)≦0.55, in particular
0.4<(x+u)/(y+v)≦0.5, and particularly preferably
0.45<(x+u)/(y+v)≦0.5.

5. The optoceramic of claim 1, wherein said crystallites have a stoichiometric composition in which the following applies,
x+u=1,
y+v=2,
z+w=4 and
2x+2u+3y+3v=8.

6. The optoceramic of claim 1, wherein E and F comprise at least 90%, preferably at least 95% and particularly preferably at least 98%, divalent anions of S, Se and O and mixtures thereof.

7. The optoceramic of claim 1, having a transparency of >50%, preferably >70%, more preferably >80%, more preferably >90%, particularly preferably >95%, outside absorption bands of said ions used for doping in a window having a width of at least 200 nm in the region of visible light having wavelengths from 380 nm to 800 nm, preferably in a window from 450 to 750 nm or in a window from 600 to 800 nm, at a sample thickness of 2 mm, preferably at a sample thickness of 3 mm, particularly preferably at a sample thickness of 5 mm.

8. The optoceramic of claim 1, having a transparency of >50%, preferably >70%, more preferably >80%, more preferably >90%, particularly preferably >95%, outside the absorption bands of said ions used for doping in a window having a width of at least 1000 nm in the infrared range from 800 nm to 5000 nm, preferably in a window from 3000 to 4000 nm, at a sample thickness of 2 mm, preferably at a sample thickness of 3 mm, particularly preferably at a sample thickness of 5 mm.

9. The optoceramic of claim 1, having a refractive index which is greater than 1.72, preferably from 1.74 to 2.3 and particularly preferably from 1.75 to 2.0.

10. The optoceramic of claim 1, having an Abbe number from 40 to 80, preferably from 50 to 70.

11. The optoceramic of claim 1, having a stress-induced birefringence of <20 nm/cm, preferably <10 nm/cm and in particular <5 nm/cm.

12. A method for manufacturing an optoceramic of claim 1, which comprises the following steps:
(1) production of a homogeneous powder mixture by mixing powder raw materials having an average primary particle diameter of 20 nm to 1 μm, preferably 20 to 500 nm, in accordance with a desired composition, optionally with addition of additives such as binders, sintering aids and dispersants in a solvent to form a slurry and drying said slurry to give a powder,
(2) production of a preform from said powder obtained in step (1),
(3) optionally burning-out of any dispersants and binders present from said preform at temperatures of 500 to 900° C.,
(4) sintering said preform at temperatures of 1400 to 1900° C. to obtain an optoceramic,
(5) optionally pressure sintering said optoceramic obtained in step (4) at 1400 to 2000° C. under a pressure of 10 to 300 MPa, preferably 50 to 250 MPa and in particular 100 to 200 MPa, and
(6) optionally oxidation of said optoceramic obtained in step (4) or (5) in a stream of O₂ at temperatures of up to 1000° C. for 5 to 10 hours.

13. An optical element, comprising an optoceramic of claim 1.

14. The optical element of claim 13, which is an optical element selected from the group consisting of laser ceramics, filters and optical converters.

15. A laser system, comprising an optical element of claim 13.

16. A method for producing an optical element comprising forming an optoceramic of claim 1.
